(19) United States
(12) Patent Application Publication
(10) Pub. No.: US 2003/0006904 A1
(43) Pub. Date: Jan. 9, 2003

(54) Infrared remote control

(76) Inventor: Kuo-Cheng Chen, Taipei (TW)

Correspondence Address: RABIN & CHAMPAGNE, P.C., Suite 1111, 1725 K Street, Washington, DC, 20006, US

(21) Appl. No.: 09/897,981

(22) Filed: Jul. 5, 2001

(51) Int. Cl. G08C 19/00

(52) U.S. Cl. 340/825.69

(57) ABSTRACT

An infrared remote control comprising a power supply circuitry, a switch circuitry and an infrared receiving circuitry. The power supply circuitry is connected to the power outlet and offers the electrical power to the internal circuitry. The switch circuitry is connected to the power supply circuitry on one side; the other end is connected to a home appliance. The infrared receiving circuitry is connected to the switch circuitry. An infrared receiver is within the infrared receiving circuitry; when the infrared receiver receives the signals from an infrared transmitter, it triggers the infrared receiving circuitry to control the switch circuitry to be on or off, and turn on or off the attached appliances.

### BACKGROUND OF THE INVENTION

I. Field of the Invention

This invention relates generally to an infrared remote control and, more specifically, to a infrared remote control that applies infrared to remotely turn on and off home appliances.

II. Description of the Prior Art

Heretofore, it is known that most of television sets, stereo systems and air conditioners have remote controls to them turn on and off, and set the other different functions at distance. On the other hand, most of the small home appliances, like lamps, desk lamps, fans, de-humiditer, air cleaner only have on and off operations without other functions, they are easier to operate, therefore they are not equipped with remote control. One has to go to the location of those small appliances to turn them on and off, therefore it is not so convenience.

Since most of the appliances have remote controls, and most of the consumers are used to remote controls. For those appliances only have on and off operations are not equipped with remote control, might cause troublesome and inconvenience. Especially for elderly and disabled people, while they are home alone, it is very troublesome and inconvenient to operate those appliances.

### SUMMARY OF THE INVENTION

It is therefore a primary object of the invention to provide an infrared remote control to activate home appliances with remote control.

In order to achieve the objective set forth, an infrared remote control in accordance with the present invention comprises a power supply circuitry, a switch circuitry and an infrared receiving circuitry. The power supply circuitry is connected to the power outlet and offers the electrical power to the internal circuitry. The switch circuitry is connected to the power supply circuitry on one side; the other end is connected to a home appliance. The infrared receiving circuitry is connected to the switch circuitry. An infrared receiver is within the infrared receiving circuitry; when the infrared receiver receives the signals from an infrared transmitter, it triggers the infrared receiving circuitry to control the switch circuitry to be on or off, and turn on or off the attached appliances.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a block diagram of the present invention;

FIG. 2 is a circuit diagram of the present invention.

### DESCRIPTION OF THE PREFERRED EMBODIMENT

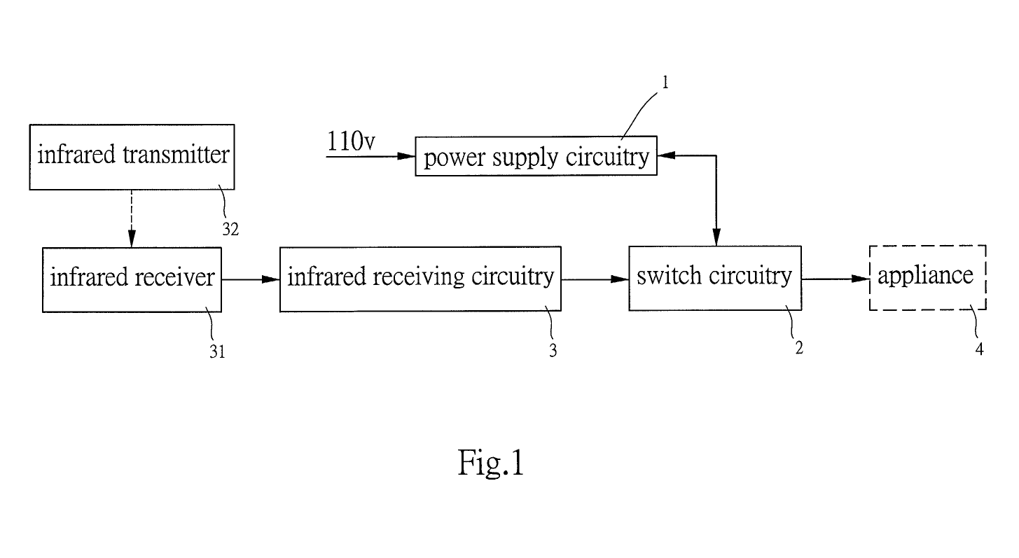

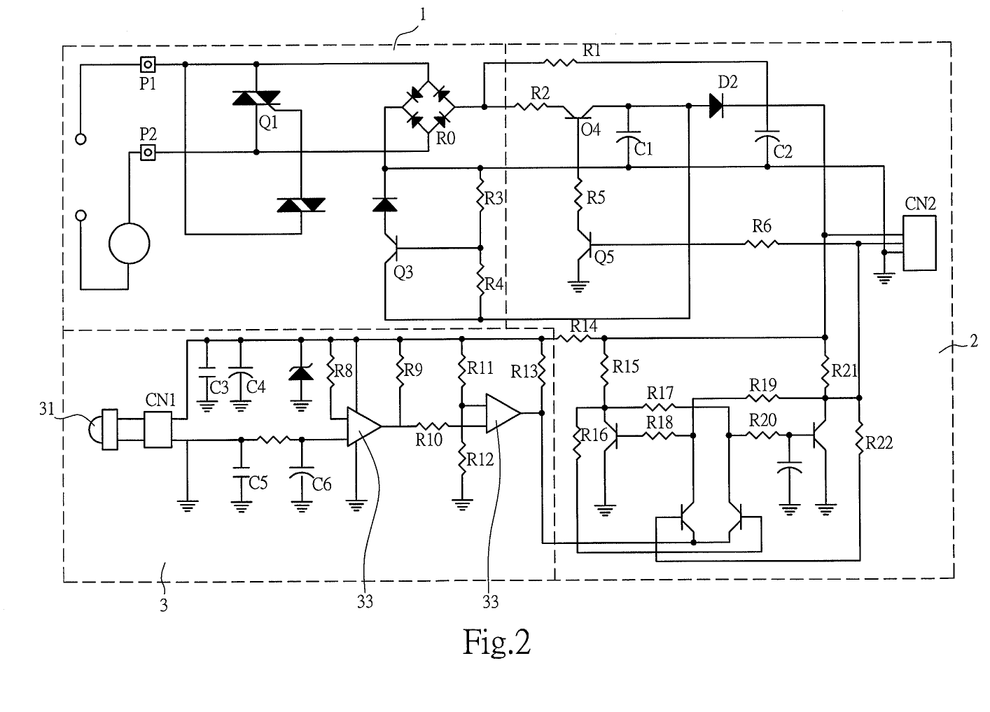

Referring to FIG. 1 and FIG. 2, the present invention is composed of a power supply circuitry 1, a switch circuitry 2 and an infrared receiving circuitry 3. The functions of each component are described below:

The power supply circuitry 1 is connected to the power outlet and offers the electrical power to the internal circuitry. The switch circuitry 2 is connected to the power supply circuitry 1 on one side; the other end is connected to a home appliance 4. The infrared receiving circuitry 3 is connected to the switch circuitry 2. An infrared receiver 31 is within the infrared receiving circuitry 3; when the infrared receiver 31 receives the signals from a infrared transmitter 32, it makes the infrared receiving circuitry 3 to control the switch circuitry 2 to be on or off, and turn on or off the attached appliance 4.

Based on above description, the infrared receiver 31 receives the signals from the infrared transmitter 32 and makes the comparator 33 of the infrared receiving circuitry 3 changes the state from low to high. At the same time the switch circuitry 2 also changes from low to high; this can make power supply circuitry 1 conduct, and change the switch circuitry 2 to on state, and turn on the appliance 4.

If the infrared transmitter 32 sends signals again, the infrared receiver 31 receives the signals and makes the comparator 33 of the infrared receiving circuitry 3 change the state from high to low. At the same time the switch circuitry 2 also changes from high to low; this can make power supply circuitry 1 disconnect, change the switch circuitry 2 to off state and turn off the appliance 4. Repeat pressing the infrared transmitter 32 can turn on and off the appliance 4.

For those appliance 4 have only on and off operations, they can connect to one switch at the same time and control with the same infrared transmitter 32 remotely.

While a preferred embodiment of the invention has been shown and described in detail, it will be readily understood and appreciated that numerous omissions, changes and additions may be made without departing from the spirit and scope of the invention.

What is claimed is:

1. An infrared remote control comprising:
a power supply circuitry is connected to the power outlet and offers the electrical power to the internal circuitry;
a switch circuitry connected to said power supply circuitry on one side and a home appliance on the other side;
an infrared receiving circuitry connected to said switch circuitry, an infrared receiver is within said infrared receiving circuitry,
an infrared transmitter sending signals to said infrared receiver, when said infrared receiver receives signals, it makes said infrared receiving circuitry to control said switch circuitry to be on or off, and turn on or off the attached appliances.
